(19) United States
(12) Patent Application Publication
(10) Pub. No.: US 2006/0127645 A1
(43) Pub. Date: Jun. 15, 2006

(54) Flat-cable-coating material and flat cable

(76) Inventors: Hideki Imamura, Tokyo-To (JP); Yaichirou Hori, Tokyo-To (JP); Hiroshi Yamamoto, Tokyo-To (JP)

Correspondence Address: OLIFF & BERRIDGE, PLC, P.O. BOX 19928, ALEXANDRIA, VA, 22320, US

(21) Appl. No.: 10/560,117

(22) PCT Filed: May 31, 2004
(86) PCT No.: PCT/JP04/07502

§ 371 Date: Dec. 9, 2005

(30) Foreign Application Priority Data
Jun. 11, 2003 (JP) 2003-166944

(51) Int. Cl. B32B 5/14

(52) U.S. Cl. 428/170

(57) ABSTRACT

A flat-cable-coating material includes a base film, and a heat-bonding layer(P+V) laminated to the base film and containing at least a filler(P) and a thermoplastic resin(V). The mass ratio (P)/(P+V) changes in a direction along the thickness of the heat-bonding layer in an inclined distribution curve preferably so as to decrease from the inner surface of the heat-bonding layer on the side of the base film toward the outer surface of the heat-bonding layer from 90% by mass and to 50% by mass. The filler(P) includes at least a hydrated metal compound(P₁) and the mass ratio (P₁/P) of the mass of the hydrated metal compound(P₁) to the mass of the filler(P) changes in a direction along the thickness of the heat-bonding layer in a distribution curve so that the mass ratio (P₁/P) decreases from the inner surface of the heat-bonding layer on the side of the base film toward the outer surface of the heat-bonding layer from 80% by mass to 0% by mass.

### TECHNICAL FIELD

The present invention relates to a flat-cable-coating material and, more specifically, to a flat-cable-coating material having both fire retardancy and adhesion to conductors for coating a flat cable employed in electric devices and electronic devices, and a flat cable coated with the flat-cable-coating material.

### BACKGROUND ART

Electronic devices, such as OA machines and game machines, are provided with flat cables for the electrical connection of a computer and electronic parts and for wiring. The flat cable is extended in the narrow case of the electronic device, slides as the electronic parts move and is used in a hot environment heated by heat generated by the electronic parts. Therefore, the flat-cable-coating material coating the flat cable must be resistant to high temperatures, fire-retardant, insulating, easily bendable and flexible. The flat-cable-coating material must be adhesive to conductors (heat-bondable) and must have an autohesion property to ensure satisfactory bending, and must have blocking resistance to facilitate manufacturing work.

Blocking is undesirable adhesion that occurs when a sheet formed by coating a base film with a thermal adhesion layer is rolled in a roll between the thermal adhesion layer and the uncoated surface of the base film. Blocking makes unwinding the sheet impossible or, if the roll is forcibly unwound, causes either the thermal adhesion layer or the base film to break or causes the thermal adhesion layer, which should not come off the base film, to come off the base film. The blocking resistance prevents such blocking and ensures the winding and unwinding of the sheet without causing blocking.

Global environmental protection has led to restrictions in the use of harmful materials so as to prevent of environmental destruction due to the disposal of used devices and materials. Thus it is required to make every effort to avoid using harmful substances as materials for forming the flat cable.

### PRIOR ART

A known nonhalogenous, fire-retardant flat cable has a thermoplastic polyester resin film, a base film, and an adhesive layer containing a phosphorous fire retardant formed on the base film (Patent document 1 and Patent document 2). A known nonhalogenous, fire-retardant adhesive includes a polyester resin (base film), a polyphosphate fire-retardant and an organic flame-retardant containing nitrogen in a nonpolyphosphate (Patent document 3).

The fire retardancy of all those flat cables is dependent on the fire retardancy of the adhesive layer (or a sticking layer in some patent documents). The adhesion of the adhesive layer to conductors decreases if the fire retardant content of the adhesive layer is increased to enhance fire retardancy. The fire retardancy of the adhesive layer decreases if the fire retardant content of the adhesive layer is reduced to enhance the adhesion of the adhesive layer to conductors. Thus adhesion to conductors and fire retardancy are incompatible with each other.

Patent document 1: JP 9-221642 A

Patent document 2: JP 9-279101 A

Patent document 3: JP 2001-89736 A

### DISCLOSURE OF THE INVENTION

The present invention has been made to solve those problems and it is therefore an object of the present invention to form a heat-bonding layer including at least a filler and a thermoplastic resin, in which the ratio of the mass of the filler to the mass of the heat-bonding layer changes in a direction along the thickness of the heat-bonding layer in an inclined distribution curve. Preferably, the ratio of the mass of the filler to the mass of the heat-bonding layer changes along a distribution curve decreasing from the side of a base film toward the surface of the heat-bonding layer to provide a flat cable coating material capable of ensuring both adhesion, such as autohesion between coating materials, and fire retardancy, satisfactory in blocking resistance facilitating manufacturing work, and excellent in heat resistance, insulation, bending property and flexibility, and to provide a flat cable.

A flat-cable-coating material according to the present invention includes: a base film; and a heat-bonding layer laminated directly or indirectly through another layer to the base film; wherein the heat-bonding layer includes a filler(P) and a thermoplastic resin(V), the mass ratio (P)/(P+V) of the mass of the filler(P) to the mass of the heat-bonding layer(P+V) changes in a direction along the thickness of the heat-bonding layer in an inclined distribution curve.

The flat-cable-coating material according to the present invention is characterized in that the mass ratio (P)/(P+V) of the mass of the filler(P) to the, mass of the heat-bonding layer(P+V) changes in a distribution curve so that the mass ratio (P)/(P+V) decreases from the inner surface of the heat-bonding layer on the side of the base film toward the outer surface of the heat-bonding layer.

The flat-cable-coating material according to the present invention is characterized in that the mass ratio (P)/(P+V) changes in a distribution curve between 90% by mass and 50% by mass.

The flat-cable-coating material according to the present invention is characterized in that the filler(P) includes a hydrated metal compound(P₁) and component fillers(P₂, P₃, . . . and Pₙ), and the mass ratio (P₁/P) of the mass of the hydrated metal compound(P₁) to the sum of the masses of the filler(P=P₁, P₂, P₃, . . . and Pₙ) changes in a direction along the thickness of the heat-bonding layer in a distribution curve so that the mass ratio (P₁/P) decreases from the inner surface of the heat-bonding layer on the side of the base film toward the outer surface of the heat-bonding layer.

The flat-cable-coating material according to the present invention is characterized in that the mass ratio (P₁/P) of the mass of the hydrated metal compound(P₁) to the mass of the filler(P) (P=P₁, P₂, P₃, . . . and Pₙ) changes in a distribution curve changing between 80% by mass and 0% by mass.

The flat-cable-coating material according to the present invention is capable of ensuring both adhesion, such as autohesion between coating materials, and fire retardancy, and is excellent in blocking resistance facilitating manufacturing work.

The flat-cable-coating material according to the present invention is characterized in that the filler(P) includes nitrogen compounds, phosphorous compounds or halogen compounds, and the mass ratios of the of those compounds to the filler(P) change in a direction along the thickness of the heat-bonding layer in inclined distribution curves.

The flat-cable-coating material according to the present invention is characterized in that the filler includes a nitrogen compound and a phosphorous compound, the mass ratio of the mass of the nitrogen compound to the mass of the heat-bonding layer changes in a distribution curve so that the mass ratio increases from the outer surface of the heat-bonding layer on the side of the base film toward the outer surface of the heat-bonding layer, and the mass ratio of the mass of the phosphorous compounds to the mass of the heat-bonding layer changes in a distribution curve so that the mass ratio decreases from the inner surface of the heat-bonding layer on the side of the base film toward the outer surface of the heat-bonding layer.

The flat-cable-coating material according to the present invention is excellent particularly in fire retardancy.

The flat-cable-coating material according to the present invention is characterized in that the filler(P) includes compounds other than halogen compounds, or compounds other than halogen compounds and phosphorous compounds, the mass ratios of the mass of those compounds to the mass of the filler(P) change in a direction along the thickness of the heat-bonding layer in inclined distribution curves.

The flat-cable-coating material according to the present invention places slight load on the environment.

The flat-cable-coating material according to the present invention is characterized in that the filler(P) is in filler particles.

A flat cable according to the present invention includes: a plurality of linear conductors extended in a plane; and a pair of flat-cable-coating materials sandwiching the conductors; wherein each of the flat-cable-coating materials includes a base film and a heat-bonding layer laminated directly or indirectly through another layer to one surface of the base film, the heat-bonding layer contains a filler(P) and a thermoplastic resin(V), the mass ratio (P)/(P+V) of the mass of the filler(P) to the mass of the heat-bonding layer(P+V) changes in a direction along the thickness of the heat-bonding layer in an inclined distribution curve.

The flat cable according to the present invention meets incompatible, required physical properties, such as fire retardancy, heat resistance, insulation, bendability, flexibility and interlayer adhesive strength.

### BRIEF DESCRIPTION OF THE DRAWINGS

FIG. 1 is a typical sectional view of a flat-cable-coating material in a preferred embodiment according to the present invention;

FIG. 2 is a typical view of a flat cable in a preferred embodiment according to the present invention;

FIG. 3 is a sectional view taken on the line A-A in FIG. 2;

FIG. 4 is a sectional view of a heat-bonding layer according to the present invention;

FIG. 5 is a graph of assistance in explaining the distribution of the components of the heat-bonding layer according to the present invention; and

FIGS. 6(A)-6(D) are graphs of assistance in explaining respective distributions of the components of the heat-bonding layer according to the present invention.

### BEST MODE FOR CARRYING OUT THE INVENTION

Preferred embodiments of the present invention will be described with reference to the accompanying drawings.

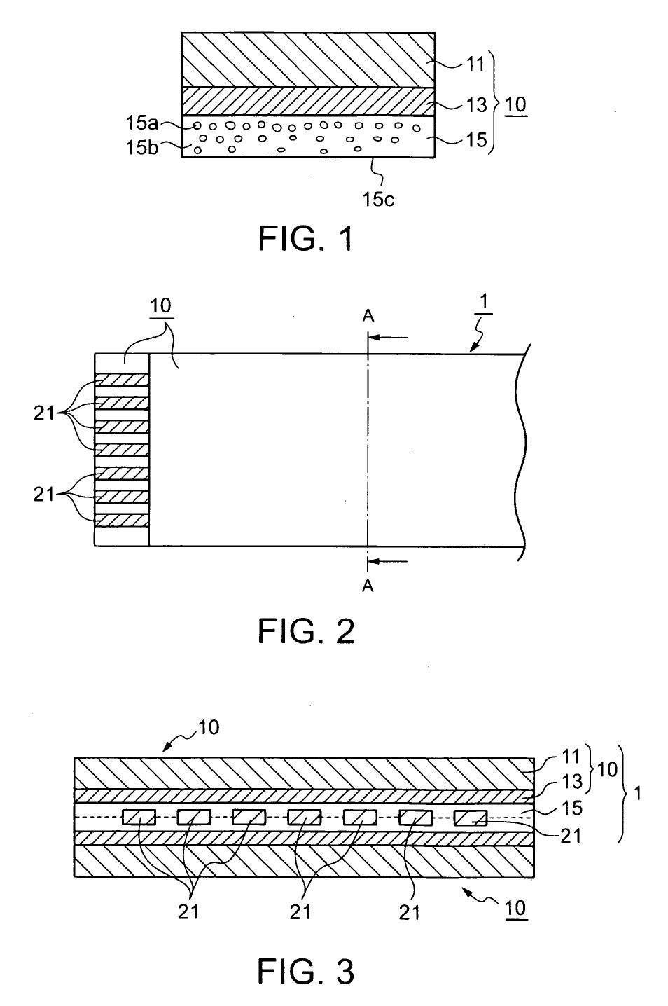

FIG. 1 is a typical sectional view of a preferred embodiment according to the present invention.

Basic Construction

A flat-cable-coating material 10 according to the present invention includes a base film 11, and a hot-bonding layer 15 laminated directly or indirectly through other layers to one of the surfaces of the base film 11. The other layers are a primer layer 13 for firmly bonding together the base film 11 the hot-bonding layer 15 and an intermediate layer used when necessary.

The heat-bonding layer(P+V+additives) 15 includes at least a filler(P) 15a and a thermoplastic resin(V) 15b. The filler(P) 15a contains at least a hydrated metal compound(P₁). Preferably, the filler(P) further contains an inorganic compound(P₂) other than the hydrated metal compound and/or other fillers(P₃, P₄, P₅, . . . and Pₙ).

The other additives of the heat-bonding layer(P+V+other additives) 15 are dispensable components and do not have a significant influence on the technical idea of the present invention. Therefore, the indication of the other additives will be omitted and the heat-bonding layer 15 will be denoted by “(P+V) 15” in this specification.

The mass ratio of the mass of the filler(P) 15a contained in the heat-bonding layer(P+V) 15 to the mass of the heat-bonding layer(P+V) 15 changes in a direction along the thickness of the heat-bonding layer 15 in a distribution curve preferably decreasing from the side of the base film 11 toward the surface 15c of the heat-bonding layer 15. The filler(P) 15a contains at least a hydrated metal compound(P₁). The ratio of the mass of the hydrated metal compound(P₁) to the sum of the masses of component fillers(P₁+P₂+ . . . +Pₙ) changes in a distribution curve decreasing from the side of the base film 11 toward the surface 15c of the heat-bonding layer 15.

FIG. 2 is a typical view of a flat cable in a preferred embodiment according to the present invention, in which an end part is shown in a partially cutaway view.

A flat cable 1 according to the present invention includes a plurality of generally parallel linear conductors 21 extended in a plane, and a pair of flat-cable-coating materials 10 sandwiching the conductors 21. Each of the flat-cable-coating materials 10 is the same in construction as that shown in FIG. 1. Preferably, the flat cable 1 of the present invention is formed by placing the two flat-cable-coating materials 10 with their heat-bonding layers 15 thereof opposite to each other, and sandwiching the conductors 21 of a metal or the like between the opposed heat-bonding layers 15.

### FEATURE OF THE INVENTION

As mentioned above, the flat-cable-coating material 10 is required to have an adhesive property for adhesion to conductors (hereinafter, referred to also as “heat-sealing property”), an autohesion property for adhesion between the same coating materials, and blocking resistance to facilitate manufacturing work. Hereinafter, the adhesive property for adhesion to conductors and the autohesion property will be referred inclusively, in some cases, simply as “adhesive property”. The flat cable 1 is required to have fire retardancy, heat resistance, insulation, bendability, flexibility and interlayer adhesive strength, which are incompatible with each other. It has been difficult for the heat-bonding layer particularly to cope with both fire retardancy and adhesion. The adhesive properties of the heat-bonding layer including ability to heat-seal conductors and autohesion of the heat-bonding layer deteriorate if the fire retardant content of the heat-bonding layer is increased to enhance fire retardancy. Therefore, it has been impossible for a single homogeneous heat-bonding layer to have both the fire retardancy and the adhesion.

The inventors of the present invention proposed, in JP 10-83721 A, a laminated structure formed by laminating a base, a heat-bonding layer containing a fire-retardant filler, and a very thin heat-bonding layer containing a blocking-resistant filler in very small contents in that order. This laminated structure is unsatisfactory in blocking resistance, requires severe management of manufacturing processes and has unstable ability.

The inventors of the present invention made assiduous studies to determine the optimum filler content of the heat-bonding layer, to distribute filler content in a direction along the thickness of the heat-bonding layer in an inclined distribution curve and to determine an optimum filler content distribution, and have made the present invention.

### INDUSTRIAL APPLICABILITY

The flat-cable-coating material and the flat cable of the present invention are applicable to the electrical connection of the components of personal computers, OA machines, such as printers or copying machines, electronic apparatus, such as portable telephones and game machines, display apparatus, such as liquid crystal displays, transportation machinery, such as automobiles, computers, power sources, displays or sensors, and to various electric wiring systems.

The flat-cable-coating material is capable of coating not only conductors, but also optical fibers and such. The flat cable can be used as a power cable and a signal cable to be connected to displays and sensors, and can be applied to displays and controllers.

Description of Materials, Constitution and Method

Materials and methods used by the present invention will be described.

Base Film

Various types of films can be selectively used according to uses as the base film 11, provided that the films have high mechanical strength, heat resistance, chemical resistance, solvent resistance, a bending property and an insulating property. Possible materials for forming the base film 11 are polyester resins including polyethylene terephthalate resins, polybutylene terephthalate resins, polyethylene naphthalate resins, ethylene glycol terephthalic acid-isophthalic acid copolymers and terephthalic acid-cyclohexanedimethanol-ethylene glycol copolymers; polyamide resins including nylon 6, nylon 66 and nylon 610; polyolefin resins including polypropylene resins and polymethylacrylate resins; acrylic resins including polyacrylate resins and polymethylacrylate resins, polyimide resins including polyimide resins, polyamide-imide resins and polyetherimide resins; fluorocarbon resins; polyether sulfone resins; polyether ketone resins; polyether sulfide resins, polyacrylate resins; polyester ether resins; aromatic amide resins; polyaramide resins; polyaramid resins; and polycarbonate resins. These resins are used individually or in mixed resins including alloys.

The base film 11 may be a single film of any one of those resins or a laminated film consisting of a plurality of films of any one of those resins. Although the base film 11 may be either of a stretched film and an unstretched film, it is preferable that the base film 11 is a uniaxially stretched or biaxially stretched film having an improved strength. It is desirable to use a polyalkylene terephthalate film, such as a polyethylene terephthalate film or a polyethylene naphthalate film, as the base film 11 from the viewpoint of mechanical strength, heat resistance insulating ability and cost. Polyethylene terephthalate resins are optimum materials for forming the base film 11.

Normally, the thickness of the base film 11 is between 5 and 200 μm. The suitable thickness of the base film 11 is in the range of 10 to 100 μm. The base film 11 has insufficient strength and makes it difficult to form the primer layer 13 and the heat-bonding layer 15 thereon when the thickness of the base film 11 is below 5 μm. The base film 11 is unsatisfactory in flexibility and a sliding property when the thickness of the base film 11 is not smaller than 200 μm. The base film 11 having a thickness in the thickness range specified by the present invention is suitable for forming the flat-cable-coating material 10 having a necessary strength and satisfactory flexibility.

When necessary, the base film 11 may contain additives, such as a filler, a plasticizer and an antistatic agent. The filler may be an extender pigment, such as silica or calcium carbonate. Possible antistatic agents are nonionic, surface active agents, anionic surface active agents, cationic surface active agents and polyamide and acrylic resins.

When necessary, the surface of the base film 11 may be processed by a corona discharge process, an ozone process, a low-temperature plasma process using oxygen or nitrogen gas, a glow discharge process or a chemical process to enhance adhesion between the base film and the heat-bonding layer and durability.

Primer

The flat-cable-coating material may be provided with the primer layer 13 generally called an undercoating, an anchor coating or a primer coating.

Possible materials for forming the primer layer 13 are, for example, polyfunctional compounds having isocyanate groups, blocked isocyanate groups and/or carbodiimide groups and polyester and polyurethane resins having a glass transition point in the range of about 20 to about 100° C., preferably, in the range of 30 to 100° C.

Possible materials for forming the anchor coating 13 are, for example, polyethylene-imine compounds, organic titanium compounds, isocyanate compounds, polyurethane compounds and polybutadiene compounds.

A desired one of those materials is dissolved or dispersed in a solvent to prepare a coating solution. The coating solution is applied to the surface of the base film 11 in a layer by a printing method, such as a gravure printing method, or a coating method, such as a roll coating method, a reverse-roll coating method, a gravure coating method, a reverse gravure coating method, a bar coating method, a rod coating method, a kiss-roll coating method, a knife coating method, a die coating method, a comma coating method, a flow coating method or a spray coating method. The layer of the coating solution is dried to form the primer layer 13. The thickness of the primer layer 13 is between about 0.05 and about 10 μm, preferably, between 0.1 and 5 μm. The primer layer 13 bonds the base film 11 and the heat-bonding layer 15 firmly together. Thus, the flat-cable-coating material withstands friction to which the flat-cable-coating material is subjected when the flat cable is used in an electronic device, the separation of the layers is prevented, and the flat-cable-coating material has improved insulating ability and improved durability.

Heat-Bonding Layer

The heat-bonding layer 5 is formed on the base film 11 or on the primer layer 13 formed on the base film 11 when necessary. The heat-bonding layer 15 must be highly flexible and capable of being bonded to the base film 11 or the primer layer 13, and the conductors 21 by heat sealing. The two heat-bonding layers 15 must be capable of sandwiching conductors of a metal or the like, of being softened, melted and caused to bond firmly together by autohesion when heated and compressed with hot rolls or hot plates, excellent in adhesion to conductors, and capable of holding conductors therein without. forming any gaps.

As mentioned above, the heat-bonding layer(P+V) 15 consists of the filler(P) and the thermoplastic resin(V). The filler(P) contains at least a hydrated metal compound(P₁). Preferably, the filler(P) contains, in addition to the hydrated metal compound, an inorganic compound(P₂) and/or other fillers(P₃, P₄, P₅, . . . and Pₙ). Thus the heat-bonding layer(P+V)=the filler(P)+the thermoplastic resin(V), where filler(P)=(P₁+P₂+P₃+P₄+ . . . +Pₙ).

When necessary, the heat-bonding layer may contain other additives in addition to the filler(P) and the thermoplastic resin(V).

Materials for forming the heat-bonding layer 15 will be described.

Thermoplastic Resin

The thermoplastic resin 15b forming the heat-sealable heat-bonding layer 15 melts and becomes capable of autohesion when heated. Preferably, the thermoplastic resin 15b is highly adhesive to conductors. Possible thermoplastic resins are, for example, polyethylene resins, polypropylene resins, ionomers, ethylene-vinyl acetate copolymers, ethylene-methacrylic acid copolymers, ethylene-(meth)acrylate copolymers, acid-denatured polyolefin resins, ethylene-propylene copolymers, vinyl acetate resins, (meth)acrylic resins, polystyrene resins, polyvinyl chloride resins, polyacrylonitrile resins, polybutene resins, polypentene resins, polyester resins, polyvinyl acetal resins and thermoplastic polyurethane resins.

A polyester resin that can be easily bonded to conductors by heat sealing and can facilitate mixing a fire retardant therein is preferable as the thermoplastic resin 15b forming the heat-bonding layer 15. A composite resin containing, as a principal component, a saturated interpolyester resin having a glass transition point in the range of −50 to 80° C. and a weight-average molecular weight in the range of 7,000 to 50,000 is a suitable polyester resin for forming the heat-bonding layer 15. A mixed resin prepared by mixing a highly flexible polyester resin having a comparatively low glass transition point and a highly heat-resistant polyester resin having a comparatively high glass transition point may be used for forming the heat-bonding layer 15. A mixed resin prepared by mixing an amorphous polyester resin and a crystalline polyester resin may be used for forming the heat-bonding layer 15.

Filler

The filler(P) 15a may be a halogen compound, such as a fluorine compound or bromine compound, a hydrated metal compound, a metal oxide compound, a metal compound powder, phosphorous and phosphorous compound or a nitrogen compound.

A principal function (object) of the filler 15a is to give the heat-bonding layer 15 fire retardancy. The filler 15a also prevents blocking when the flat-cable-coating material formed by forming the heat-bonding layer on the base film is wound in a roll. The filler 15a is able to provide other functions when combined with the thermoplastic resin 15b and processed by under proper processing conditions.

Possible chlorine compounds are, for example, chlorinated paraffin, chlorinated polyethylene, chlorinated polyphenyl, perchloropentacyclodecane, HET anhydride and chlorendic acid.

Possible bromine compounds are, for example, tetrabromobisphenol A (TBA), decabromodiphenyl oxide (DBDPO), hexabromocyclodecane (HBCD), octabromodiphenyl oxide (OBDPO), bis(tribromophenoxy)ethane (BTBPE)., tribromophenol (TBP), ethylene-bis-tetrabromophthalimide, TBA carbonate oligomer, polystyrene bromide, TBA epoxy oligomer, TBA epoxy polymer, ethylene-bis-pentabromodiphenyl, polydibromophenylene oxide, hexabromobenzene, tetrabromoethane, decabromobiphenylether, tetrabromophthalic anhydrate, tribromophenylmaleimide, tetrabromopentaerythritol, tris(pentabromobenzyl)isocyanurate and ammonium bromide.

Possible phosphorous and phosphorous compounds are, for example, red phosphorous, phosphates or phosphorous compounds including ammonium polyphosphate, triallyl phosphate, alkyl aryl phosphate, alkyl phosphate, phosphorinate, dimethyl phosphonate, halogenated phosphonate, trimethyl phosphate, triethyl phosphate, tributyl phosphate, trioctyl phosphate, tributoxyethyl phosphate, octyl diphenyl phosphate, tricresyl phosphate, cresyl diphenyl phosphate, triphenyl phosphate, tris(chloroethyl)phosphate, tris(2-chloropropyl)phosphate, tris(2,3-dichloropropyl)phosphate, tris(2,3-dibromchloropropyl)phosphate, tris(2,3-dibromopropyl phosphate, bis(2,3-dibromopropyl)-2,3-dichloropropyl phosphate, bis(chloropropyl)-monooctyl phosphate, polyphosphonate, polyphosphate, aromatic polyphosphate and dibromoneopentyl glycol, and polyol compounds including polyol phosphonates, polyol phosphates and polyol halides.

Possible nitrogen compounds are, for example, urea and triazine compounds including melamine derivatives. Triazine compounds are, for example, melamine(triamide cyanurate), ammeryn(diamide cyanurate), ammeryd(monoamide cyanurate), melamine sulfate, melamine pyrophosphate, guanylmelamine sulfate, ethylenedimelamine, trimethyldimelamine, tetramethyidimelamine, hexamethylenedimelamine, 1,3-hexylenedimelamine, homoguanamine, acetoguanamine sulfate, benzoguanamine, benzguanamine, acetoguanamine, phthalodiguanamine, butylenediguanamine, norbornanediguanamine, methylenediguanamine, melamine cyanurate(condensate of melamine and cyanuric acid), isocyanurate, melam, melam sulfate, melem sulfate, and melamine resins.

Hydrated Metal Compound

Possible hydrated metal compounds are, for example, aluminum hydroxide, magnesium hydroxide, zirconium hydroxide, calcium hydroxide, barium hydroxide, titanium hydroxide and zinc hydroxide. Aluminum hydroxide and magnesium hydroxide are preferable owing to their excellent fire retardancy and low cost. Those hydrated metal compounds may be used either individually or in combination.

Metal Oxide Compound

Possible metal oxide compounds are, for example, antimony trioxide, antimony pentoxide, tin oxide, molybdenum oxide, boron oxide, silicon dioxide, copper oxide, zirconium oxide and zinc borate. These metal oxide compounds may be used either individually or in combination.

Other possible metal compounds and inorganic compounds are metal powders or inorganic compounds including antimony trichloride, antimony borate, boric acid, antimony molybdate, molybdenum oxides, phosphorous-nitrogen compounds, calcium-aluminum silicate, zirconium compounds, tin compounds, dawsonite, hydrated calcium aluminate, copper powder, calcium carbonate and barium metaborate, zinc stannate and molybdenum oxide. A silicone polymer, ferrocene, fumaric acid, maleic acid and sulfamic acid are possible additives. These materials may be used either individually or in combination.

Those fillers including those halogen compounds including chlorine compounds and bromine compounds, hydrated metal compounds, metal oxide compounds or metal compounds including metal powders, phosphorous and phosphorous compounds and the nitride compounds are generally called fire retardants and fire-retardant additives.

The filler(P) 15a is added to the heat-bonding layer 15 in filler particles.

The average particle size of primary particles of the filler, namely, the fire retardant, is in the range of about 0.01 to about 100 μμ, preferably, in the range of 0.01. to 40 μm. The average particle size must be equal to or less than the thickness t of the heat-bonding layer. Particles having an average particle size exceeding 40 μm cannot be satisfactorily dispersed in synthetic resins and, sometimes, deteriorates the physical properties of synthetic resins. When necessary, a filler, a pigment, a lubricant, an antistatic agent, a foaming agent and/or a plasticizer may be added to the composition.

Global environmental protection has a tendency to restrict the use of harmful materials for environmental protection. Thus it is required to make every effort to avoid using harmful substances as materials for forming the flat cable 1. For example, it is possible that decabromodiphenyl oxide (DBDPO), a bromine compound (fire retardant), and a chlorine compound (fire retardant) produce dioxin or a dioxin-related substance when burnt under a certain burning condition. Phosphorous compounds (fire retardants) are possible to cause the danger of environmental pollution and hence it is desired to avoid using phosphorous compounds. When Flat cables provided with flat-cable-coating materials containing those fire retardants are disposed of together with electronic devices, it is possible that the fire retardants are emitted into the environment and are taken in by human bodies to injure health. Therefore, it is preferable from the viewpoint of environmental protection that those fire retardants do not contain halogen compounds. It is most preferable that those fire retardants do not contain both halogen compounds and phosphorous compounds.

Other Fillers

When necessary, a pigment, a lubricant, an antistatic agent, a dispersant, an antioxidant, a corrosion inhibitor, antiblocking agent, a coupling agent that can react with both the resin and the fire retardant to enhance binding force between the resin and the fire retardant, a filler and/or a fire-retardant catalyst may be added to the composition forming the heat-bonding layer such that those substances do not affect adversely to the effect of the present invention.

Other Additives

When necessary, a plasticizer, a crosslinking agent, a crosslinking auxiliary and/or a foaming agent may be added to the composition forming the heat-bonding layer in addition to the foregoing fillers. These additives are mixed in the thermoplastic resin.

Usually, the composition forming the heat-bonding layer 15 contains the filler 15a, such as a fire retardant, and the thermoplastic resin 15b. The filler content of the composition is in the range of about 50 to about 80% by mass. Although the composition contains the filler in a large filler content from the point of view of fire retardancy, the composition cannot be spread in a satisfactory film in forming the heat-bonding layer and a heat-bonding layer having a necessary adhesive ability cannot be formed if the filler content is excessively large and the thermoplastic resin content is excessively small. Therefore, the filler content of a composition satisfactory in fire retardancy and workability is limited inevitably to the foregoing range.

According to the present invention, although the heat-bonding layer(P+V) 15, similarly to the conventional heat-bonding layer, consists of the filler(P) and the thermoplastic resin(V), the ratio of the mass of the filler(P) to the mass of the heat-bonding layer(P+V), namely, the filler content (P)/(P+V) % by mass changes in an inclined distribution curve decreasing from the side of the base film toward the surface of the heat-bonding layer, preferably, in a direction along the thickness of the heat-bonding layer, and the filler content (P)/(P+V) changes in a distribution curve between 90% by mass and 50% by mass. The content is expressed in percent by mass in this specification unless otherwise specified. It is liable to occur that a dope (ink) is difficult to apply and, even if the dope is applied, a normal coating cannot be formed when the filler content of the dope is above the upper limit of this range, and a dope (ink) has insufficient fire retardancy and unsatisfactory blocking resistance when the filler content of the dope is below the lower limit of this range.

When the filler content (P)/(P+V) is distributed in a direction along the thickness of the heat-bonding layer in the inclined distribution curve, the workability does not deteriorate, the autohesion and adhesion to conductors are satisfactory even if the filler content is increased. The heat-bonding layer has remarkably improved autohesion and adhesion to conductors even if the average filler content of the composition is equal to the filler content of the conventional composition. Preferably, the inclined distribution curve indicating the distribution of the content declines from the side of the base film toward the surface of the heat-bonding layer. When the distribution curve thus declines, the foregoing effect is remarkable. When a filler that does not have a significant influence on the autohesion and adhesion to conductors of the heat-bonding layer even if the filler content increases from the side of the base film toward the side of conductors is used, the filler content may increase toward the side of conductors. Essentially, a filler that has an influence on autohesion and adhesion to conductors is contained in a reduced filler content in a boundary part of the heat-bonding layer, contiguous with conductors,

The filler(P) includes at least a hydrated metal compound(P₁) and, preferably, further includes a inorganic compound (P₂) other than hydrated metal compounds and/or other component fillers(P₄, P₅, . . . and Pₙ) including a fire retardant(P₃); that is, (P) =(P₁+P₂+P₃+P₄+ . . . +Pₙ).

The mass ratio (P₁)/(P) of the mass of the hydrated metal compound(P₁) to the mass of the filler(P) (P=P₁, P₂, P₃, . . . and Pₙ) changes between 80% by mass and 0% by mass, preferably, between 70% by mass and 0% by mass, in a distribution curve decreasing from the side of the base film 11 toward the surface of the heat-bonding layer 15 (in a flat cable, toward the conductors).

Since the hydrated metal compound(P₁) affects the autohesion and adhesion to conductors, the hydrated metal compound(P₁) content in a surface part of the heat-bonding layer 15, contiguous with conductors, is decreased. When the hydrated metal compound(P₁) is used in combination with other component fillers, the hydrated metal compound(P₁) content, namely, (P₁)/(P+V), in a boundary part of the heat-bonding layer 15, contiguous with conductors, may be reduced to zero ((P₁)/(P)=0), and the other component fillers may be distributed in the boundary part of the heat-bonding layer 15 in a desired filler content (P)/(P+V) preferably between 50 and 90%. Adhesion decreases, when the ratio (P₁)/(P) exceeds the foregoing range. The foregoing effects are enhanced when the ratio (P₁)/(P) is within the foregoing range. The effect can be further enhanced by meeting the condition for the mass ratio (P₁)/(P) and the filler content (P)/(P+V) in the range of 50 to 90% by mass.

Preferably, the filler(P) includes an inorganic compound(P₂) other than the hydrated metal compound and/or a fire retardant, such as a nitrogen or phosphorous compound, and/or a halogen compound(fire retardant)(P₃) in addition to the hydrated metal compound(P₁).

The inorganic compound(P₂) other than the hydrated metal compound is for example, a metal oxide compound, such as antimony trioxide.

The inorganic compound content (P₂)/(P) (percent by mass) of the filler(P) is distributed in an inclined distribution curve between 100 and 0% by mass, preferably, between 95 and 15% by mass. The fire retardant content (P₃)/(P) of the filler(P) is distributed in an inclined distribution curve between 0 and 60% by mass, preferably, between 5 and 60% by mass.

The inorganic compound(P₂) and the fire retardant(P₃) have an insignificant effect on autohesion and adhesion to conductors. Therefore, the influence of the inorganic compound(P₂) and the fire retardant(P₃) on adhesion is insignificant when the organic compound(P₂) and the fire retardant(P₃) contents are in the foregoing content ranges and is more insignificant when their contents are in the foregoing preferable content ranges.

The filler content (P)/(P+V), where (P) is the sum of the masses of the hydrated metal compound(P₁), the inorganic compound(P₂) and the other component fillers(P₄, . . . and Pₙ), (V) is the mass of the thermoplastic resin, and (P+V) is the mass of the heat-bonding layer, is in the range of 90 to 50% by mass. The respective masses of the hydrated metal compound(P₁), the inorganic compound(P₂) and the other component fillers(P₄, . . . and Pₙ) may be properly determined. The range of the inclined distribution curve and its effect are explained in the description of examples and comparative examples.

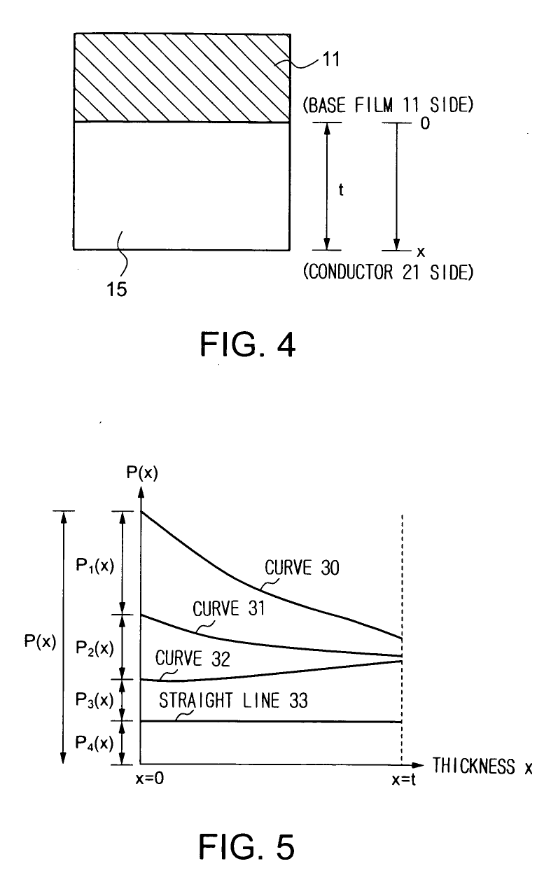

FIG. 4 is a sectional view of the heat-bonding layer according to the present invention.

FIG. 5 is a graph of assistance in explaining the inclined distribution of the components of the heat-bonding layer according to the present invention.

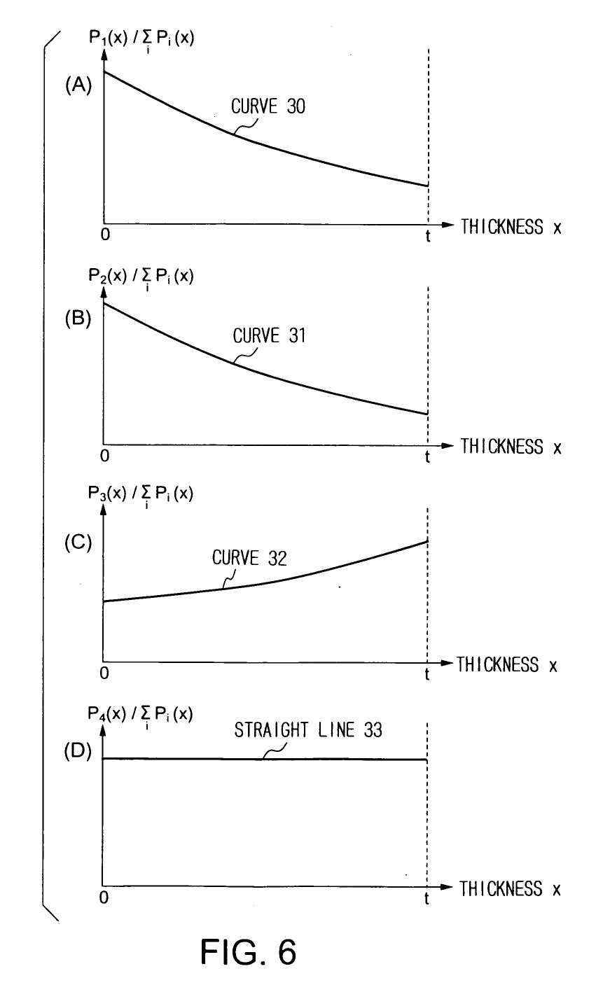

FIGS. 6(A)-6(D) are graphs of assistance in explaining respective inclined distributions of the components of the heat-bonding layer according to the present invention.

Referring to FIG. 4, the thickness of the heat-bonding layer 15 is indicated by t and x is measured on the x-axis parallel to the thickness of the heat-bonding layer 15. A point x=0 is in the interface between the base film 11 and the heat-bonding layer 15, and a point x=t is on the surface of the heat-bonding layer 15 contiguous with the conductors 21.

Suppose that the mass of a unit volume of the thermoplastic resin(V) is V(x), the mass of a unit volume of the filler(P) is P(x) and the masses of the component fillers(P₁, P₂, . . . , P₁, . . . and Pₙ) (N≧1) are P₁(x), P₂(x), . . . , P₁(x) . . . and Pₙ(x) at a position at x.

The filler content C(x) decreases with x, and 50% by mass ≦C(x)<90% by mass.
P(x)=P₁(x)+P₂(x)+ . . . +P₁(x)+ . . . +Pₙ(x)
C(x)=P(x)/{P(x)+V(x)}

Adhesion decreases with the increase of the content P₁(x) of the hydrated metal compound(P₁). Therefore, the distribution curve representing the distribution of the content P₁(x) of the hydrated metal compound(P₁) must be represented by a decreasing function of x. In FIG. 5, a curve 30 indicates the distribution of the filler content P(x). The filler having insignificant effect on the decrease of adhesion, such as the inorganic compound(P₂) or the fire retardant(P₃), may have content P₁(x) distributed in a distribution curve represented by an increasing or stationary function of x.

Referring to FIG. 5, a distribution curve 31 representing the sum of the content P₂(x) of the component filler(P₂), the content P₃(x) of the component filler(P₃) and the content P₄(x) of the component filler(P₄), a distribution curve 32 representing the sum of the content P₃(x) of the component filler(P₃) and the content P₄(x) of the component filler(P₄), and a distribution curve 33 representing the content P₄(x) of the component filler(P₄) are superposed on the distribution curve 30.

The interval between the curves 30 and 31 is the content P₁(x) of the component filler(P₁) the interval between the curves 32 and 33 is the content P₃(x) of the component filler(P₃) and the interval between the curve 33 and the x-axis is the content P₄(x) of the component filler(P₄).

As obvious from FIG. 5, the contents of the component filler(P₁) and the component filler(P₂) are represented by decreasing functions of x (thickness). The content of the component filler(P₃) is distributed in an increasing function of x (thickness). The content of the component filler(P₄) is distributed in a stationary function of x (thickness). The distribution of the filler content P(x) is represented by a decreasing function of x (thickness). Curves shown in FIG. 6 represent the respective variations of P₁(x), P₂(x), P₃(x) and P₄(x) with x.

The filler content according to the present invention is determined on the basis of the following deign concept. Basic design intends to determine the filler content P(x) of the fillers that improves the fire retardancy of the heat-bonding layer 15 and decreases the adhesion of the heat-bonding layer 15 such that the distribution of the filler content P(x) is represented by a decreasing function of x representing a curve like the curve 30 shown in FIG. 5. Thus the filler content P(x) is high on the side of the base film 11 and is low on the side of the conductors 21.

The individual fillers are distributed in the filler in the following manner.

(1) The filler includes the component fillers having a significant effect on the reduction of adhesion, such as hydrated metal compounds including aluminum hydroxide and magnesium hydroxide, so that the ratio of the mass of those component fillers to the mass of the filler is represented by a decreasing function of x expressed by Expression (1).

$$Pi ( x ) / {\sum }_{i} Pi ( x ) \qquad ( 1 )$$

(2) The filler includes the component fillers having little effect on the reduction of adhesion, such as melamine sulfate, namely, a nitrogen compound, and silica, so that the ratio of the mass of those component fillers to the mass of the filler is represented by an increasing function of x expressed by Expression (2).

$$Pi ( x ) / {\sum }_{i} Pi ( x ) \qquad ( 2 )$$

According to the filler ratio is expressed by Expression (3).

$$Pi ( x ) / {\sum }_{i} Pi ( x ) \qquad ( 3 )$$

The phosphorous compound is a component filler the distribution of which is represented, similarly to that of the hydrated metal compound, by a decreasing function of x.

Method of Forming Heat-Bonding Layer

A composite dope ink having a viscosity between about 10 and about 4000 cps for forming the heat-bonding layer 15 is made by dissolving or dispersing a thermoplastic resin, a filler and, when necessary, desired additives in a solvent or a diluent, such as toluene, xylene, methyl ethyl ketone, methyl isobutyl ketone, cyclohexanone, ethyl acetate, butyl acetate or isopropyl alcohol, to prepare a mixture and kneading the mixture.

The composite dope is applied to the base film 11 to form a film of the composite cope by a coating method, such as a roll coating method, a reverse-roll coating method, a gravure coating method, a reverse-gravure coating method, a bar coating method, a rod coating method, a kiss-roll coating method, a knife coating method, a die coating method, a comma coating method, a flow coating method or a spray coating method. The film of the composite dope is dried to form the dry heat-sealable heat-bonding layer 15 containing a fire retardant and having a thickness in the range of about 15 to about 150 μm (in dry state), preferably, in the range of 10 to 40 μm (in dry state).

The heat-bonding layer 15 is formed so that the filler content is distributed in a direction along the thickness of the heat-bonding layer 15 in an inclined distribution curve. The filler content can be distributed in such an inclined distribution curve by a phase separation method, a repetitive coating method including several coatings or a slide coating method.

The phase separation method includes phase separation that occurs while the composite dope for forming the heat-bonding layer 15 applied to the base film is dried. For example, suppose that it is desired to decrease the hydrated metal compound content of the heat-bonding layer 15 toward the surface 15c of the heat-bonding layer 15 not contiguous with the base film 11. Application speed is controlled so that the film of the composite dope formed on the base film 11 may dry in a predetermined time. The filler migrates due to the difference in specific weight between the thermoplastic resin and the filler or due to the evaporation of the solvent before the film of the composite dope dries. The phase separation is promoted by reducing the viscosity of the composite dope so that the filler migrates toward the base film 11 and the filler content is distributed in a desired distribution curve.

The repetitive coating method uses a plurality of kinds of composite dopes respectively having different filler contents, such as hydrated metal compound contents. The method has film forming cycles each including an application operation and drying operation for those plurality of kinds of composite dopes to form component coatings respectively having different filler contents successively to form the laminated heat-bonding layer 15. Since the component coatings consist of the same resin and the same solvent, the adjacent component coatings are compatible. Consequently, the component coatings merge together to form the substantially unitary heat-bonding layer 15 having the filler content distributed in an inclined distribution curve. The range of content distribution in the heat-bonding layer 15 is dependent on the content of the composite dope. Although the repetitive coating method seems to need many steps, the heat-bonding layer 15 can be easily formed by the repetitive coating method because a coating machine provided with a plurality of coating units is installed generally in a flat-cable-coating material producing line.

In the slide coating method, a plurality of composite dopes respectively having different filler contents are extruded for forming the heat-bonding layer 15 through a multilayer die in layers of the composite dope. The layers of the composite dopes merge together into a single layer. The layer is dried after being attached to the base film to form the heat-bonding layer 15. The content is distributed in the heat-bonding layer 15 in a desired content range dependent on the component contents of the composite dopes.

Flat Cable

Referring to FIGS. 2 and 3, the flat cable 1 according to the present invention includes the plurality of parallel conductors 21 extended in a plane, and the pair of flat-cable-coating materials 10 sandwiching the conductors 21. Flat-cable-coating materials, sandwich the conductors 21 arranged in a plane between the two flat-cable-coating materials. At least one of the flat-cable-coating materials or, preferably, both of the flat-cable-coating materials are the flat-cable-coating materials 10, with the heat-bonding layers 15 of the flat-cable-materials 10 opposed to each other.

The assembly of the flat-cable-coating materials 10 and the conductors 21 is heated and compressed for heat sealing. Consequently, the heat-sealable heat-bonding layers 15 of the flat-cable-coating materials 10 and the conductors 21 are bolded closely together (conductor bonding) and the heat-bonding layers 15 bond together by autohesion. Thus, the conductors 21 are embedded in the heat-bonding layers 15 to complete the flat cable 1.

There is not any particular restriction on the sectional shape of the conductors 21. the conductors may be elongate strips having a suitable sectional shape, such as a circular, elliptic, rectangular or flat rectangular shape. the conductors 21 may be optical fibers. The conductors 21 may have be arranged in any suitable manner, such as one of straight, meandering, sinusoidal, zigzag manners, or a combination of those manners, provided that the conductors are arranged in a plane.

### EXAMPLES

Examples will be described. The present invention is not limited to the examples that will be specifically described herein. An example 5 is one of the best modes for carrying out the present invention.

### Example 1

A primer layer having a thickness of 1 μm (dry state) was formed on a 23 μm thick PET film (GEC-23, Teijin DuPont corp.) by applying a primer dope of a composition mentioned below to the PET film in a primer dope film and drying the primer dope film.

The primer dope was prepared by mixing solutions A and B immediately before application. The solution A was prepared by dissolving a polyester resin having a glass transition point of 40° C. and a polyol urethane resin (solid mass ratio: 1:1, hydroxyl group value: 10 mgKOH/g) in a mixed solvent of 1/1 methyl ethyl ketone/toluene. The solution B was prepared by dissolving tolylenediisocyanate and hexamethylenediisocyanate n a mixed solvent of 1/1 methyl ethyl ketone/toluene.

A heat-bonding layer having a thickness of 40 μm (dry state) was formed on the primer layer to complete a flat-cable-coating material in Example 1. The heat-bonding layer was formed by applying a composite hot-bonding dope of a composition mentioned below to the primer layer in a layer of the composite hot-bonding dope by a comma coater at a coating speed of 5 m/min, and drying the layer of the composite hot-bonding dope without blowing air in the front half of a drying zone and blowing hot air in the back half of the drying zone.

The composite hot-bonding dope having a viscosity of 100 cps was prepared by dissolving the following resin mixture, filler mixture and additives in a mixed solvent of 1/1 methyl ethyl ketone/toluene. The mixed resin contained 20 parts by mass of polyester resin having a glass transition point of −30° C., 4 parts by mass of polyester resin having a glass transition point of 5° C. and 1.2 parts by mass of polyester resin having a glass transition point of 80° C. The filler mixture contained 42 parts by mass of aluminum hydroxide, 26.6 parts by mass of antimony trioxide, 4 parts by mass of melamine sulfate and 1 part by mass of silicon dioxide. The additives were 1.7 parts by mass of polyester plasticizer and 0.5 parts by mass of dispersant.

Measurement

Mass ratios of the components of the composition forming the hot-bonding layer of the flat-cable-coating material in a 3 μm thick inner part contiguous with the base film and a 3 μm thick outer part contiguous with the surface facing conductors were measured. The inner and the outer parts were scraped off, the components and their ratios were measured by a known gravimetric method by means of dry ashing, XRD (x-ray diffraction) and XRFS (x-ray fluorescent spectrometry). Measured data is shown in Table 1. As obvious from Table 1, the component contents of the inner part are different from the corresponding component contents of the outer part, and the contents are distributed in inclined distribution curves.

TABLE 1

| | Example 1 | | Example 2 | | Example 3 | | Example 4 | |
|---|---|---|---|---|---|---|---|---|
| | Inner | Outer | Inner | Outer | Inner | Outer | Inner | Outer |
| Items | part | part | part | part | part | part | part | part |
| P:V | 74.8:25.2 | 70:30 | 74.8:25.2 | 70:30 | 74.8:25.2 | 70:30 | 74.8:25.2 | 65:35 |
| Component V (Resin) | 25.2 | 30 | 25.2 | 30 | 25.2 | 30 | 25.2 | 35 |
| Component P | | | | | | | | |
| A1(OH)₃ | 43.6 | 40.1 | 43.6 | 0 | 43.6 | 0 | 43.6 | 37 |
| | (58.3) | (57.3) | (58.3) | (0) | (58.3) | (0) | (58.3) | (56.9) |
| Sb₂O₃ | 26.7 | 24.4 | 26.7 | 64.5 | 26.7 | 65.8 | 26.7 | 22.5 |
| | (35.7) | (34.9) | (35.7) | (92.2) | (35.7) | (94) | (35.7) | (34.6) |
| Melamine | 4 | 4 | 4 | 4 | 4 | 3.7 | 4 | 4 |
| sulfate | (5.3) | (5.7) | (5.3) | (5.7) | (5.3) | (5.3) | (5.3) | (6.2) |
| SiO₂ | 0.5 | 1.5 | 0.5 | 1.5 | 0.5 | 0.5 | 0.5 | 1.5 |
| | (0.7) | (2.1) | (0.7) | (2.1) | (0.7) | (0.7) | (0.7) | (2.3) |

| | | | | |
|---|---|---|---|---|
| Rating | | | | |
| Fire | O | O | O | O |
| retardancy | | | | |
| Adhesion to | O | O | O | O |
| conductors | | | | |
| Blocking | O | O | O | O |
| resistance | | | | |

Since a plasticizer and a dispersant, namely, other additives, are merged with the thermoplastic resin, listing of data on the additives on Table 1 is omitted. In Table 1, unparenthesized numerals are in part by mass and parenthesized numerals are in percent by mass.

### Examples 2 to 4

Flat-cable-coating materials were made by a method similar to that of fabricating the flat-cable-coating material in Example 1, except that the former method adjusted conditions for application and drying such that the 3 μm thick inner part and the 3 μm thick outer part of each heat-bonding layer have component contents shown in Table 1.

### Examples 5

First and second dopes of compositions mentioned below were used. A first layer was formed on a base film by applying the first dope to the base film in a first dope layer at a coating speed of 25 m/min by a comma coater and drying the first dope layer with hot air in a drying zone. Then, the second layer was formed on the first layer by applying the second dope to the first layer in a second dope layer at a coating speed of 25 m/min by a comma coater and drying the second dope layer with hot air in a drying zone. The first and the second layers were formed such that a hot-bonding layer having a thickness of 40 μm in dry state is formed on the base film to form a flat-cable-coating material.

The first dope having a viscosity of 700 cps for forming the first layer was prepared by dissolving a mixture of a component thermoplastic resin including 20 parts by mass of polyester resin having a glass transition point of −30° C., 4 parts by mass of polyester resin having a glass transition point of 5° C. and 1.2 parts by mass of polyester resin having a glass transition point of 80° C., a filler including 43.6 parts by mass of aluminum hydroxide, 26.7 parts by mass of antimony trioxide, 4 parts by mass of melamine sulfate and 0.5. parts by mass of silicon dioxide, 1.7 parts by mass of polyester plasticizer and 0.5 part by mass of dispersant in a mixed solvent of 1/1 methyl ethyl ketone/toluene.

The second dope having a viscosity of 300 cps for forming the second layer was prepared by dissolving a mixture of a component thermoplastic resin including 28.5 parts by mass of polyester resin having a glass transition point of −30° C., 5.0 parts by mass of polyester resin having a glass transition point of 5° C. and 1.5 parts by mass of polyester resin having a glass transition point of 80° C., a filler including 59.5 parts by mass of antimony trioxide, 4 parts by mass of melamine sulfate and 1.5 parts by mass of silicon dioxide, 1.7 parts by mass of polyester plasticizer and 0.5 part by mass of dispersant in a mixed solvent of 1/1 methyl ethyl ketone/toluene.

### Example 6

First, second and third dopes of compositions mentioned below were used respectively for forming first, second and third layers by successively spreading the first to the third dope on a base film in dope layers at a coating speed of 30 m/min by a comma coater and successively drying the dope layers with hot air in a drying zone. The first to the third layer were formed such that a hot-bonding layer having a thickness of 40 μm in dry state is formed on the base film to form a flat-cable-coating material.

The first dope having a viscosity of 700 cps for forming the first layer was prepared by dissolving a mixture of a component thermoplastic resin including 20 parts by mass of polyester resin having a glass transition point of −30° C., 4 parts by mass of polyester resin having a glass transition point of 5° C. and 1.2 parts by mass of polyester resin having a glass transition point of 80° C., a filler including 43.6 parts by mass of aluminum hydroxide, 26.7 parts by mass of antimony trioxide, 4 parts by mass of melamine sulfate and 0.5 parts by mass of silicon dioxide, 1.7 parts by mass of polyester plasticizer and 0.5 part by mass of dispersant in a mixed solvent of 1/1 methyl ethyl ketone/toluene.

The second dope having a viscosity of 500 cps for forming the second layer was prepared by dissolving a mixture of a component thermoplastic resin including 24.8 parts by mass of polyester resin having a glass transition point of −30° C., 4 parts by mass of polyester resin having a glass transition point of 5° C. and 1.2 parts by mass of polyester resin having a glass transition point of 80° C., a filler including 22.5 parts by mass of aluminum hydroxide, 38.2 parts by mass of antimony trioxide, 3.8 parts by mass of melamine sulfate and 0.5 parts by mass of silicon dioxide, 1.7 parts by mass of polyester plasticizer and 0.5 part by mass of a dispersant in a mixed solvent of 1/1 methyl ethyl ketone/toluene.

The third dope having a viscosity of 300 cps for forming the third layer was prepared by dissolving a mixture of a component thermoplastic resin including 28.5 parts by mass of polyester resin having a glass transition point of −30° C., 5 parts by mass of a polyester resin having a glass transition point of 5° C. and 1.5 parts by mass of polyester resin having a glass transition point of 80° C., a filler including 61.0 parts by mass of antimony trioxide, 3.5 parts by mass of melamine sulfate and 0.5 parts by mass of silicon dioxide, 1.7 parts by mass of a polyester plasticizer and 0.5 part by mass of a dispersant in a mixed solvent of 1/1 methyl ethyl ketone/toluene.

### Examples 7 to 12

Hot-bonding layers each having a 3 μm thick inner part on the side of a base film and a 3 μm thick outer part on the side of conductors having material contents shown in Tables 2 and 3 were formed. Flat-cable-coating materials in Examples 9, 10 and 11 were formed by a method similar to that of forming the flat-cable-coating material in Example 1, except that the method of forming the flat-cable-coating materials in Examples 9 and 10 used decabromodiphenyl oxide (DBDPO), i.e., a halogen compound, instead of melamine sulfate, i.e., nitrogen compound, and the method of forming the flat-cable-coating material in Example 11 used ammonium polyphosphate, i.e., a phosphorous compound, instead of melamine sulfate.

TABLE 2

| | Example 5 | | Example 6 | | Example 7 | | Example 8 | |
|---|---|---|---|---|---|---|---|---|
| | Inner | Outer | Inner | Outer | Inner | Outer | Inner | Outer |
| Items | part | part | part | part | part | part | part | part |
| P:V | 74.8:25.2 | 65:35 | 74.8:25.2 | 65:35 | 72.8:27.2 | 60:40 | 74.8:25.2 | 60:40 |
| Component V (Resin) | 25.2 | 35 | 25.2 | 35 | 27.2 | 40 | 25.2 | 40 |
| Component P | | | | | | | | |
| A1(OH)₃ | 43.6 | 0 | 43.6 | 0 | 43.6 | 33.9 | 43.6 | 0 |
| | (58.3) | 0 | (58.3) | (0) | (58.3) | (56.5) | (58.3) | (0) |
| Sb₂O₃ | 26.7 | 59.5 | 26.7 | 61 | 26.7 | 20.6 | 26.7 | 54.5 |
| | (35.7) | (91.5) | (35.7) | (94) | (35.7) | (34.3) | (35.7) | (90.8) |
| Melamine | 4 | 4 | 4 | 3.5 | 4 | 4 | 4 | 4 |
| sulfate | (5.3) | (6.2) | (5.3) | (5.3) | (5.3) | (6.7) | (5.3) | (6.7) |
| SiO₂ | 0.5 | 1.5 | 0.5 | 0.5 | 0.5 | 1.5 | 0.5 | 1.5 |
| | (0.7) | (2.3) | (0.7) | (0.7) | (0.7) | (2.5) | (0.7) | (2.5) |

| | | | | |
|---|---|---|---|---|
| Rating | | | | |
| Fire | O | O | O | O |
| retardancy | | | | |
| Adhesion to | O | O | O | O |
| conductors | | | | |
| Blocking | O | O | O | O |
| resistance | | | | |

TABLE 3

| | | | Example 9 | | Example 10 | | Example 11 | | Example 12 | |
|---|---|---|---|---|---|---|---|---|---|---|
| | | | Inner | Outer | Inner | Outer | Inner | Outer | Inner | Outer |
| Items | | | part | part | part | part | part | part | part | part |
| P:V | | | 62.3:37.7 | 57.43 | 61.5:38.5 | 57.43 | 60:40 | 57:43 | 62.3:37.7 | 60:40 |
| Component V (Resin) | | | 37.7 | 43 | 38.5 | 43 | 40 | 43 | 37.7 | 40 |
| Component P | A1(OH)₃ | | 27.8 | 0 | 28.2 | 0 | 22.3 | 10 | 27.8 | 12 |
| | | | (44.6) | (0) | (45.8) | (0) | (37.2) | (17.5) | (44.6) | (20) |
| | Sb₂O₃ | | 9.8 | 0 | 9.8 | 25.8 | 9.8 | 25 | 9.8 | 9.8 |
| | | | (15.7) | (0) | (15.9) | (45.3) | (16.3) | (43.9) | (15.7) | (16.3) |
| | Fire | Nitrogen | — | — | — | — | — | — | 20.4 | 35.2 |
| | Retardant | compound | | | | | | | (32.7) | (58.7) |
| | | Phosphorous | — | — | — | — | 27.9 | 20.1 | — | — |
| | | compound | | | | | (46.5) | (35.3) | | |
| | | Halogen | 20.4 | 17.9 | 20.7 | 28.2 | — | — | — | — |
| | | compound | (32.7) | (31.4) | (33.7) | (49.5) | | | | |

| | | | | | | | | | |
|---|---|---|---|---|---|---|---|---|---|
| | SiO₂ | 4.3 | 1.9 | 2.8 | 3 | 3 | 1.9 | 4.3 | 3 |
| | | (7.0) | (3.3) | (4.6) | (5.2) | (5.0) | (3.3) | (7.0) | (5.0) |
| Rating | Fire | O | O | O | O | | | | |
| | retardancy | | | | | | | | |
| | Adhesion to | O | O | O | O | | | | |
| | conductors | | | | | | | | |
| | Blocking | O | O | O | O | | | | |
| | resistance | | | | | | | | |

Note
The nitrogen fire retardant is melamine sulfate, phosphorous fire retardant is a ammonium polyphosphate, the halogen fire retardant is decabromodiphenyl oxide (DBDPO).

### Comparative Example 1

A flat-cable-coating material in Comparative example 1 was made by a method similar to that of fabricating the flat-cable-coating material in Example 1, except that the former method used a dope of a composition mentioned below for forming a heat-bonding layer. The heat-bonding layer having a thickness of 40 μm in dry state was formed on a base film by applying the dope to the base film in a dope layer at a coating speed of 10 m/min by a comma coater and drying the dope layer with hot air of 120° C. in six drying zones of 18 m in overall length. The dope having a viscosity of 2000 cps for forming the heat-bonding layer was prepared by dissolving a mixture of a component thermoplastic resin including 50 parts by mass of polyester resin having a glass transition point of −30° C., 8 parts by mass of a polyester resin having a glass transition point of 5° C. and 2 parts by mass of polyester resin having a glass transition point of 80° C., a filler including 35.5 parts by mass of antimony trioxide, 4 parts by mass of melamine sulfate and 0.5 parts by mass of silicon dioxide, 1.7 parts by mass of polyester plasticizer and 0.5 part by mass of dispersant in a mixed solvent of 1/1 methyl ethyl ketone/toluene.

### Comparative Example 2

A flat-cable-coating material in Comparative example 2 was made by a method similar to that of fabricating the flat-cable-coating material in Comparative example 1, except that the former method used a dope of a composition mentioned below for forming a heat-bonding layer. The dope having a viscosity of 1000 cps for forming the heat-bonding layer was prepared by dissolving a mixture of a component thermoplastic resin including 35 parts by mass of polyester resin having a glass transition point of −30° C., 4 parts by mass of polyester resin having a glass transition point of 5° C. and 1 part by mass of polyester resin having a glass transition point of 80° C., a filler including 55.5 parts by mass of antimony trioxide, 4 parts by mass of melamine sulfate and 0.5 parts by mass of silicon dioxide, 1.7 parts by mass of a polyester plasticizer and 0.5 part by mass of a dispersant in a mixed solvent of 1/1 methyl ethyl ketone/toluene.

### Comparative Examples 3-to 7

Flat-cable-coating materials in Comparative examples 3 to 7 were made by a method similar to that of making the flat-cable-coating material in Example 1. Comparative examples 3 to 7 had 3 μm thick inner parts on the side of the base film and 3 μm thick outer parts on the side of the conductors having component contents given in Tables 4 and 5.

TABLE 4

| | | | |
|---|---|---|---|
| Comparative | Comparative | Comparative | Comparative |
| Example 1 | Example 2 | Example 3 | Example 4 |

| | Inner | Outer | Inner | Outer | Inner | Outer | Inner | Outer | |
|---|---|---|---|---|---|---|---|---|---|
| Items | part | part | part | part | part | part | part | part | |
| P:V | 40:60 | 40:60 | 60:40 | 60:40 | 76.8:23.2 | 76.8:23.2 | 65:35 | 76.8:23.2 | |
| Component V (Resin) | 60 | 60 | 40 | 40 | 23.2 | 23.2 | 35 | 23.2 | |
| Component P | | | | | | | | | |
| A1(OH)₃ | 0 | 0 | 0 | 0 | 44.9 | 44.9 | 0 | 44.9 | |
| | (0) | (0) | (0) | (0) | (58.5) | (58.5) | (0) | (58.5) | |
| Sb₂O₃ | 35.5 | 35.5 | | 55.5 | 55.5 | 27.4 | 27.4 | 59.5 | 27.4 |
| | (88.8) | (88.8) | (92.5) | (92.5) | (36.7) | (36.7) | (91.5) | (35.7) | |
| Melamine | 4 | 4 | 4 | 4 | 4 | 4 | 4 | 4 | |
| sulfate | (10) | (10) | (6.7) | (6.7) | (5.2) | (5.2) | (6.2) | (6.2) | |
| SiO₂ | 0.5 | 0.5 | 0.5 | 0.5 | 0.5 | 0.5 | 0.5 | 0.5 | |
| | (1.2) | (1.2) | (0.8) | (0.8) | (0.6) | (0.6) | (2.3) | (0.6) | |

| | | | | |
|---|---|---|---|---|
| Rating | | | | |
| Fire | X | X | O | X |
| retardancy | | | | |
| Adhesion to | O | O | X | X |
| conductors | | | | |
| Blocking | X | X | O | O |
| resistance | | | | |

TABLE 4

| | Comparative | | Comparative | | Comparative | |
|---|---|---|---|---|---|---|
| | Example 5 | | Example 6 | | Example 7 | |
| | Inner | Outer | Inner | Outer | Inner | Outer |
| Items | part | part | part | part | part | part |
| P:V | 74.8:25.2 | 60:40 | 95:5 | 60:40 | 76.8:23.2 | 40:60 |
| Component V (Resin) | 25.2 | 40 | 5 | 40 | 23.2 | 60 |
| Component P | | | | | | |
| A1(OH)₃ | 43.6 | 54.5 | 50.5 | 0 | 44.9 | 0 |
| | (58.3) | (90.8) | (53.2) | (0) | (58.5) | (0) |
| Sb₂O₃ | 26.7 | 0 | 40 | 54.5 | 27.4 | 55.5 |
| | (35.7) | (0) | (42.1) | (90.8) | (35.7) | (92.5) |
| Melamine | 4 | 4 | 4 | 4 | 4 | 4 |
| sulfate | (5.3) | (6.7) | (4.2) | (6.7) | (5.2) | (6.7) |
| SiO₂ | 0.5 | 1.5 | 0.5 | 1.5 | 0.5 | 0.5 |
| | (0.7) | (2.5) | (0.5) | (2.5) | (0.6) | (0.8) |

| | | | |
|---|---|---|---|
| Rating | | | |
| Fire | O | O | O |
| retardancy | | | |
| Adhesion to | X | X | O |
| conductors | | | |
| Blocking | O | O | X |
| resistance | | | |

Evaluation

The flat-cable-coating materials 10 in those examples and those comparative examples were evaluated in terms of fire retardancy, adhesion to conductors and blocking resistance.

The fire retardancy of the flat-cable-coating materials 10 was measured by a fire retardancy measuring method specified in VW-1, UL Standards. Acceptable fire retardancy is indicated by a circle and unacceptable fire retardancy is indicated by a cross in Tables 1 to 5.

Adhesion of the conductor to the heat-bonding layer was measured by a peel test method specified in K7127, JIS. A test specimen for a peel test was prepared by bonding a 100 μm thick, tin-plated soft copper conductor to the heat-bonding layer of the flat-cable-coating material 10 by a heat sealing process that pressed the soft copper conductor against the heat-bonding layer at a pressure of 29.4 N/cm² and heated the soft copper conductor and the flat-cable-coating material 10 for 3 s at 170° C. The peel strength of the soft copper conductor was measured by a peel test method specified in K7127, JIS; the soft copper conductor was pulled at a peel rate of 100 mm/min and at a peel angle of 180°. Acceptable peel strengths not lower than 0.6 N/0.8 mm are indicated by a circle and unacceptable peel strengths below 0.8 N/0.8 mm are indicated by a cross in Tables 1 to 5.

The flat-cable-coating materials 10 in those examples and those comparative examples were evaluated in terms of blocking resistance. A test specimen for a blocking resistance test was prepared by superposing ten 50 mm×50 mm pieces of each flat-cable-coating material 10 such that the base films 11 were in contact with the heat-bonding layers of the adjacent pieces, respectively, and the specimen was kept at 40° C. under a pressure of 0.5 N/cm² for seven days. The blocking resistance of the flat-cable-coating material 10 was measured by a peel test method specified in K7127, JIS; the pieces of the flat-cable-coating material 10 of the specimen were pulled at a peel rate of 10 mm/min and at a peel angle of 180° in an atmosphere of 25° C. The flat-cable-coating materials having peel strengths (blocking resistances) below 0.1 N/10 mm and resistant to the separation of the base film 11 and the heat-bonding layer 15 are indicated by a circle and the flat-cable-coating materials having peel strengths not lower than 0.1 N/10 mm are indicated by a cross in Tables 1 to 5.

As obvious from Tables 1 to 5, all the flat-cable-coating materials in Examples 1 to 12 are acceptable in terms of fire retardancy, adhesion to conductors and blocking resistance.

The flat-cable-coating materials in Comparative examples 1 and 2 are acceptable in terms of adhesion to conductors, but are unacceptable in terms of fire retardancy and blocking resistance. The flat-cable-coating materials in Comparative examples 3, 5 and 6 are acceptable in terms of fire retardancy and blocking resistance, but are unacceptable in terms of adhesion to conductors. The flat-cable-coating material in Comparative example 4 is acceptable in terms of blocking resistance, but is unacceptable in terms of fire retardancy and adhesion to conductors. The flat-cable-coating material in Comparative example 7 is acceptable in terms of fire retardancy and adhesion to conductors, but is unacceptable in terms of blocking resistance.

### Examples 13 to 25

Flat Cables

Flat cables were made using the flat-cable-coating materials in Examples 1 to 12. A parallel arrangement of seventeen tin-plated soft copper conductors of 50 μm in thickness and 0.8 mm in width was sandwiched between the two flat-cable-coating materials of 60 cm in width and 100 cm in length with the heat-bonding layers of the two flat-cable-coating materials opposed to each other, and the flat-cable-coating materials sandwiching the soft copper conductors were compressed and heated by passing the same between a metal roller heated at 150° C. and a rubber roller at a surface speed of 1 m/min to form a flat cable. The abilities of the flat cables were similar to those of the corresponding flat-cable-coating materials. The functions of the flat cables were satisfactory when the flat cables were used as wiring cables for connecting the print head and the controller of an ink-jet printer.

The flat-cable-coating materials of the present invention are capable of coping with both adhesive property including adhesion to conductors and autohesion, and fire retardancy and have excellent blocking resistance, which facilitates manufacturing work. The flat cables of the present invention satisfy heat resistance, fire retardancy, bending property and flexibility, which are physical properties incompatible with each other.

1. A flat-cable-coating material comprising:
a base film; and
a heat-bonding layer laminated directly or indirectly through another layer to the base film;
wherein the heat-bonding layer includes a filler(P) and a thermoplastic resin(V), the mass ratio (P)/(P+V) of the mass of the filler(P) to the mass of the heat-bonding layer(P+V) changes in a direction along the thickness of the heat-bonding layer in an inclined distribution curve.

2. The flat-cable-coating material according to claim 1, wherein
the mass ratio (P)/(P+V) of the mass of the filler(P) to the mass of the heat-bonding layer(P+V) changes in a distribution curve so that the mass ratio (P)/(P+V) decreases from the inner surface of the heat-bonding layer on the side of the base film toward the outer surface of the heat-bonding layer.

3. The flat-cable-coating material according to claim 2, wherein
the mass ratio (P)/(P+V) changes in a distribution curve from 90% by mass to 50% by mass.

4. The flat-cable-coating material according to claim 1, wherein
the filler(P) includes a hydrated metal compound(P₁) and component fillers(P₂, P₃, . . . and Pₙ), and the mass ratio (P₁/P) of the mass of the hydrated metal compound(P₁) to the sum of the masses of the filler (P=P₁, P₂, P₃, . . . and Pₙ) changes in a direction along the thickness of the heat-bonding layer in a distribution curve so that the mass ratio (P₁/P) decreases from the inner surface of the heat-bonding layer on the side of the base film toward the outer surface of the heat-bonding layer.

5. The flat-cable-coating material according to claim 4, wherein
the mass ratio(P₁/P) of the mass of the hydrated metal compound(P₁) to the mass of the filler(P) (P =P₁, P₂, P₃, . . . and Pₙ) changes in a distribution curve changing from 80% by mass to 0% by mass.

6. The flat-cable-coating material according to claim 1, wherein
the filler(P) includes nitrogen compounds, phosphorous compounds or halogen compounds, and the mass ratios of the of those compounds to the filler(P) change in a direction along the thickness of the heat-bonding layer in inclined distribution curves.

7. The flat-cable-coating material according to claim 6 wherein
the filler includes a nitrogen compound and a phosphorous compound, the mass ratio of the mass of the nitrogen compounds to the mass of the heat-bonding layer changes in a distribution curve so that the mass ratio increases from the inner surface of the heat-bonding layer on the side of the base film toward the outer surface of the heat-bonding layer, and the mass ratio of the mass of the phosphorous compounds to the mass of the heat-bonding layer changes in a distribution curve so that the mass ratio decreases from the inner surface of the heat-bonding layer on the side of the base film toward the outer surface of the heat-bonding layer.

8. The flat-cable-coating material according to claim 1, wherein
the filler(P) includes compounds other than halogen compounds, or compounds other than halogen compounds and phosphorous compounds, the mass ratios of the mass of those compounds to the mass of the filler(P) change in a direction along the thickness of the heat-bonding layer in inclined distribution curves.

9. The flat-cable-coating material according to claim 1, wherein
the filler(P) is in filler particles.

10. A flat cable comprising:
a plurality of linear conductors extended in a plane; and
a pair of flat-cable-coating materials sandwiching the conductors;
wherein each of the flat-cable-coating materials includes a base film and a heat-bonding layer laminated directly or indirectly through another layer to one surface of the base film, the heat-bonding layer contains a filler(P) and a thermoplastic resin(V), the mass ratio (P)/(P+V) of the mass of the filler(P) to the mass of the heat-bonding layer(P+V) changes in a direction along the thickness of the heat-bonding layer in an inclined distribution curve.
